(19) United States
(12) Patent Application Publication
(10) Pub. No.: US 2026/0161821 A1
(43) Pub. Date: Jun. 11, 2026

(54) DATA TRANSMISSION METHOD, SYSTEM, DEVICE, AND READABLE STORAGE MEDIUM

(71) Applicant: Juzhou Chen, Beijing (CN)

(72) Inventor: Juzhou Chen, Beijing (CN)

(21) Appl. No.: 18/976,265

(22) Filed: Dec. 10, 2024

(51) Int. Cl. G06F 21/62; H04L 9/08

(52) U.S. Cl. CPC G06F 21/6245; H04L 9/0825; G06F 2221/2141

(57) ABSTRACT

A data transmission method, system, device, and computer-readable storage medium are described for secure and authorized sharing of encrypted health data. Health information collected by a wearable device is encrypted using public key information to generate health data. A mobile terminal obtains user-input authorization information, generates authorization permissions, and transmits the health data and authorization permissions to a server. The server stores the data in a distributed manner, distributes it to third parties according to the authorization, and generates point reward information returned to the mobile terminal. Public key encryption and distributed storage prevent unauthorized access and data leakage, while the reward mechanism encourages user participation and data sharing.

### TECHNICAL FIELD

The present application relates to the field of data transmission technology, particularly to a data transmission method, system, device, and readable storage medium.

### BACKGROUND

With the rise of health monitoring, more and more health data are being recorded and, the health data, once being recorded in the prior art, would be directly used by third parties, leading to information leakage.

### SUMMARY

The present application provides a data transmission method, system, device, and readable storage medium for addressing the above-mentioned problems.

In the first aspect, the present application provides a data transmission method, wherein the transmission method is applied to a mobile terminal, comprising:
obtaining wearable device, the health data that is generated by the wearable device through the encryption of original health information based on public key information;
obtaining authorization information input by the user;
generating authorization permissions based on authorization information;
sending health data and authorization permissions to the server so that the server will implement distributed storage of health data and, based on the authorization permission, distribute health data to third parties and generate point reward information; and
obtaining the point reward information sent by the server.

In the second aspect, the present application also provides a data transmission method, wherein the transmission method is applied to a server, comprising:
obtaining the health data from wearable device sent by the mobile terminal;
obtaining from mobile terminal the authorization permission that is generated by the mobile terminal based on the authorization information input by the user;
storing health data in a distributed manner;
distributing health data to third parties based on the authorization permission, and generating point reward information; and
sending point reward information to the mobile terminal.

In the third aspect, the present application also provides a data transmission method, wherein the transmission method is applied to a wearable device, comprising:
obtaining original health information;
encrypting original health information using public key information to generate health data;
sending health data to the mobile terminal which sends the health data to the server.

In the fourth aspect, the present application also provides a data transmission system, wherein the transmission system comprises wearable device, mobile terminal, and server:
the wearable device is used to obtain original information, generate health data by encrypting the original health information based on public key information, and to send health data to the mobile terminal;
the mobile terminal is used to obtain the health data sent by wearable device and the authorization information input by users, generate authorization permission based on the authorization information, and send the health data and authorization permission to the server the server is used to obtain health data and authorization permission sent by the mobile terminal, store the health data in a distributed manner and, based on the authorization permission, distribute the health data to third parties, and generate and send point reward information to the mobile terminal.

In the fifth aspect, the present application also provides a data transmission device, wherein the transmission device comprises a memory and a processor;
the memory is used to store computer programs;
the processor is used to execute the computer program, and implement the data transmission method as described above when executing the computer program.

In the sixth aspect, the present application also provides a computer-readable storage medium, wherein the computer-readable storage medium stores computer programs which, when executed by a processor, enable the processor to implement the data transmission method as described above.

The present application discloses a data transmission method, system, device, and readable storage medium to obtain from wearable device the health data that is generated by the wearable device through the encryption of original health information based on public key information; obtains authorization information input by the user; generate authorization permissions based on authorization information; send health data and authorization permissions to the server so that the server will implement distributed storage of health data and, based on the authorization permission, distribute health data to third parties and generate point reward information; and obtain the point reward information sent by the server. On the one hand, the use of wearable devices to obtain health data instead of directly through mobile terminals greatly improves the convenience and sustainability of health data acquisition, and the use of public keys to encrypt the incoming and outgoing data, whether from wearable devices to mobile terminals or from mobile terminals to servers, disables the data interpretation, and the authorization permission is sent to the server for data distribution only after the user's authorization information is obtained, thus effectively protecting data, preventing unauthorized use by third parties, and reducing data leakage; on the other hand, with the consent of authorization, the server will receive reward information for data completion, thereby improving playability.

### BRIEF DESCRIPTION OF THE DRAWINGS

In order to provide a clearer explanation of the technical solution of the embodiments of the present invention, the accompanying drawings required for the description of the embodiments will be briefly introduced below. Obviously, the accompanying drawings described below are some embodiments of the present invention, and those of ordinary skill in the art can also obtain other drawings based on these ones without creative labor.

FIG. 1 is a schematic flowchart of the first embodiment of a data transmission method provided by the present application;

FIG. 2 is a schematic flowchart of a second embodiment of a data transmission method provided by the present application;

FIG. 3 is a schematic flowchart of a third embodiment of a data transmission method provided by the present application;

FIG. 4 is a schematic flowchart of the fourth embodiment of a data transmission method provided by the present application;

FIG. 5 is a schematic flowchart of a fifth embodiment of a data transmission method provided by the present application;

FIG. 6 is a schematic flowchart of the sub steps of step S54 in the flowchart shown in FIG. 5;

FIG. 7 is a schematic flowchart of a sixth embodiment of a data transmission method provided by the present application;

FIG. 8 is a schematic flowchart of the seventh embodiment of a data transmission method provided by the present application;

FIG. 9 is a schematic block diagram of the structure of the data transmission system provided in the embodiments of the present application;

FIG. 10 is a schematic block diagram of the structure of the data transmission device provided in the embodiment of the present application.

### DETAILED DESCRIPTION OF EMBODIMENTS

The technical solutions in the embodiments of the present application will be described clearly and completely in conjunction with the accompanying drawings of the embodiments of the present application. Obviously, the described embodiments are only a part of the embodiments of the present application, rather than all the embodiments. Based on the embodiments of the present application, all other embodiments obtained by those of ordinary skill in the art without creative work shall fall within the protection scope of the present application.

The flowchart shown in the attached drawing is only an example and does not necessarily include all the content and operations/steps, nor does it have to be executed in the order described, and some operations/steps, for example, can also be decomposed, combined, or partially merged, so the actual execution order may change according to the actual situation. It should be understood that the terms used in this application specification are only for the purpose of describing specific embodiments and are not intended to limit the present application. As used in the present specification and accompanying claims, the singular forms, “a”, “one”, and “the”, are intended to include the plural forms, unless the context clearly indicates otherwise.

It should also be understood that the term “and/or” used in this application specification and the accompanying claims refers to any combination of one or more of the listed items and all possible combinations, and includes these combinations.

Some embodiments of the present application will be described below in detail with reference to the accompanying drawings. Without conflict, the following embodiments and their features can be combined with each other.

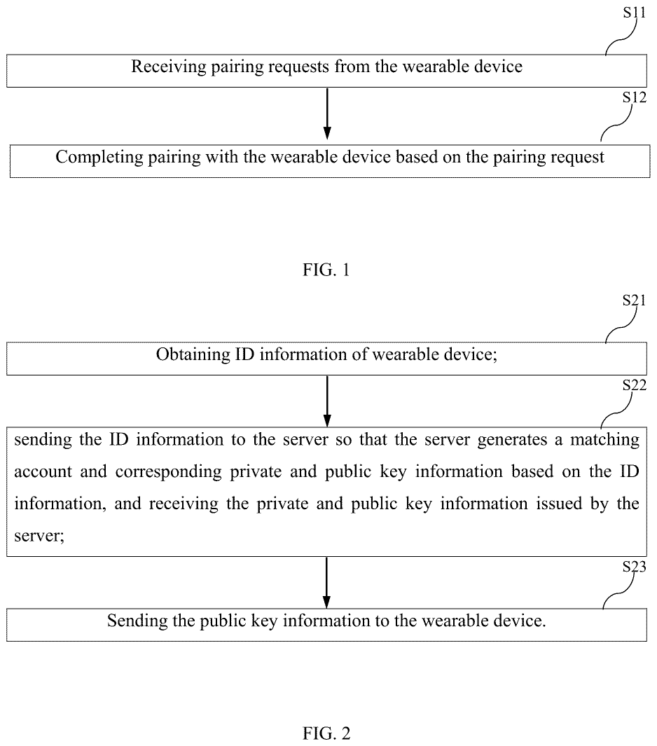

FIG. 1 presents a flow diagram of the first embodiment of the data transmission method provided by the present application, and this method can be specifically applied to mobile terminals which, optionally, can be mobile phones, tablets, laptops, and so on, comprising the following steps:

S11, receiving pairing requests from the wearable device;

Optionally, wearable devices specifically can be rings, necklaces, and watches that can monitor user health data, which can be worn directly on the user's body.

Firstly, receiving pairing requests from wearable devices, specifically, can be Bluetooth pairing request, WIFI pairing request, or other pairing requests, which are not limited here.

S12, completing pairing with the wearable device based on the pairing request.

At any time, pairing can be completed with wearable devices based on their pairing requests and, optionally, whether Bluetooth or WIFI pairing request, can be referenced to relevant pairing technologies in the market, which are not limited here.

FIG. 2 presents a flow diagram of the second embodiment of the data transmission method provided by the present application, comprising the following steps:

S21, obtaining ID information of wearable device;

Optionally, obtain the ID information of wearable device, which is the unique identification of the wearable device.

S22, sending the ID information to the server so that the server generates a matching account and corresponding private and public key information based on the ID information, and receiving the private and public key information issued by the server;

Subsequently, the ID information is sent to the server so that the server can generate matching accounts and corresponding private and public key information based on the ID information.

Optionally, the server can generate a new matching account based on the ID information, and bind the ID information to the matching account, while simultaneously generating corresponding private and public key information.

In other embodiments, the mobile terminal connects to the server in advance, and registers an account on the server through email/phone number or other means. When sending the ID information, the corresponding mobile terminal (application) matches and binds the ID with the previous account, and synchronously generates private and public key information.

S23, sending the public key information to the wearable device.

The obtained public key information is sent to the wearable device so that the wearable device can implement end-to-end encryption of original health information.

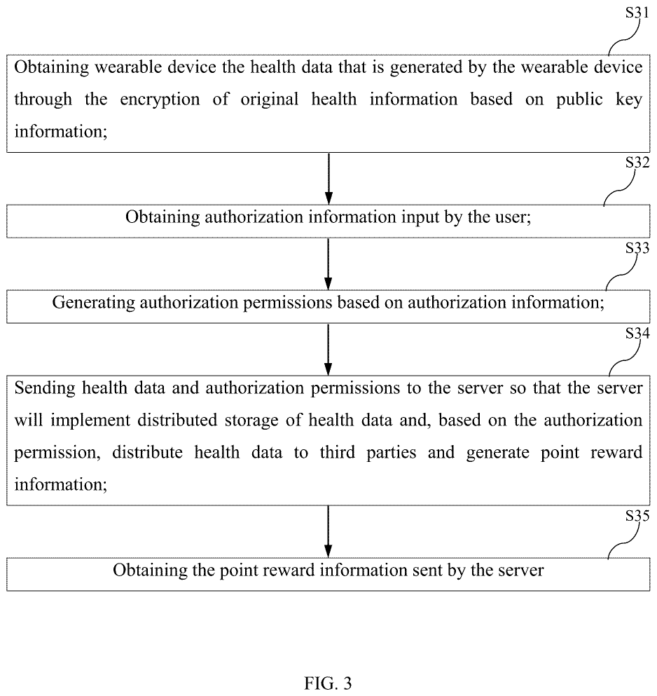

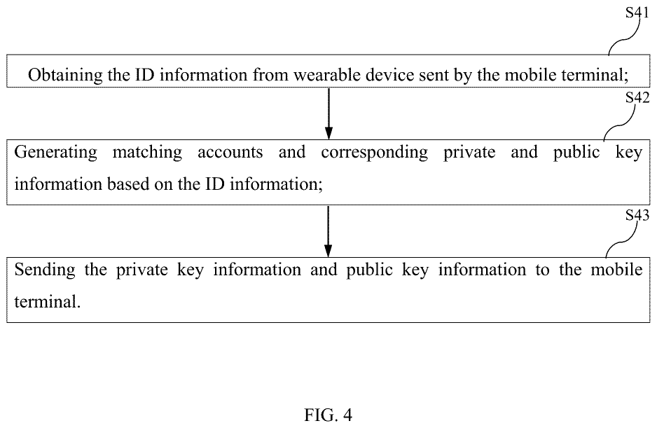

FIG. 3 presents a flow diagram of the third embodiment of the data transmission method provided by the present application, comprising the following steps:

S31, obtaining wearable device the health data that is generated by the wearable device through the encryption of original health information based on public key information;

In an optional embodiment, the health data sent by wearable device is first obtained, which is generated by the wearable device through the encryption of original health information based on the public key information.

Optionally, health data can be a series of health data that specifically indicates the user's heartbeat, sleep, blood oxygen, step count, calorie expenditure, and so on.

In an optional embodiment, the wearable device intending to send obtained original health information to the mobile terminal can generate health data through end-to-end encryption using public key information.

S32, obtaining authorization information input by the user;

Obtain authorization information input by the user. The authorization information input by the user can be displayed on the screen of the mobile terminal, indicating whether to authorize data distribution or not, can also be input/adjusted by the user through settings, or input through wearable devices, which are not limited here.

It should be noted that the steps of each embodiment of the present application, with the exception of steps S11 and S12, have no chronological order except for the logical sequence. S33, generating authorization permissions based on authorization information;

Optionally, after obtaining authorization information, if the authorization information indicates that the user agrees to the authorization, an authorization permission specifically including private key information can be generated.

S34, sending health data and authorization permissions to the server so that the server will implement distributed storage of health data and, based on the authorization permission, distribute health data to third parties and generate point reward information; and Optionally, the health data and authorization permission are sent to the server so that the server can implement distributed storage of health data, distribute health data to third parties based on the authorization permission, and generate point reward information.

Optionally, the health data and authorization permission can be sent to the server independently without any particular order, or can be sent together to the server.

Optionally, the health data can be sent to the server through further encryption using public key information, or directly, which are not limited here.

After the health data is sent to the server, the server can store the received health data in a distributed manner, specifically, storing encrypted data on the blockchain using IPFS.

After the authorization permission is sent to the server, the server can distribute health data to third parties based on the authorization permission and generate point reward information.

S35, obtaining the point reward information sent by the server.

Optionally, the point reward information sent by the server can be obtained afterwards.

The above embodiments provide a data transmission method to obtain from wearable device the health data that is generated by the wearable device through the encryption of original health information based on public key information; obtain authorization information input by the user; generate authorization permissions based on authorization information; send health data and authorization permissions to the server so that the server will implement distributed storage of health data and, based on the authorization permission, distribute health data to third parties and generate point reward information; and obtain the point reward information sent by the server. On the one hand, the use of wearable devices to obtain health data instead of directly through mobile terminals greatly improves the convenience and sustainability of health data acquisition, and the use of public keys to encrypt the incoming and outgoing data, whether from wearable devices to mobile terminals or from mobile terminals to servers, disables the data interpretation, and the authorization permission is sent to the server for data distribution only after the user's authorization information is obtained, thus effectively protecting data, preventing unauthorized use by third parties, and reducing data leakage; on the other hand, with the consent of authorization, the server will receive reward information for data completion, thereby improving playability.

FIG. 4 presents a flow diagram of the fourth embodiment of the data transmission method provided by the present application, and the method is applied to servers, comprising the following steps:
S41, obtaining the ID information from wearable device sent by the mobile terminal;
Obtain from wearable device the ID information sent by the mobile terminal.

S42, generating matching accounts and corresponding private and public key information based on the ID information;

Generate matching accounts and corresponding private and public key information based on the ID information.

S43, sending the private key information and public key information to the mobile terminal.

Send the private and public key information to the mobile terminal.

The specific process has already been explained in the above embodiments, which will not be elaborated here.

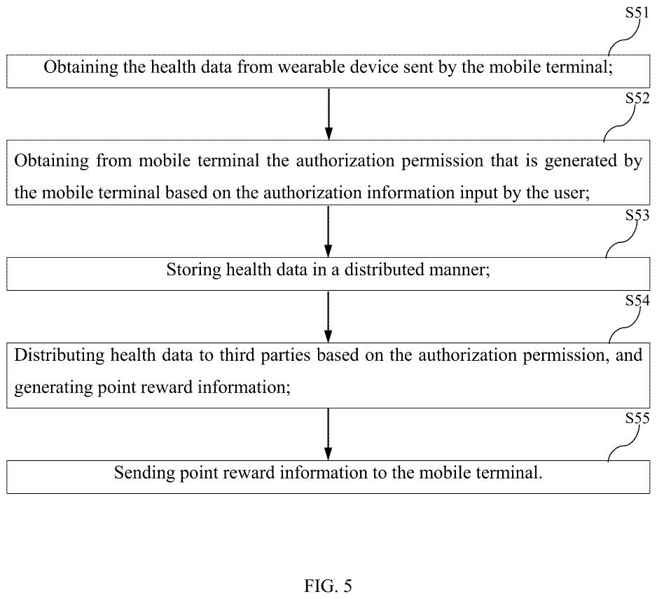

FIG. 5 presents a flow diagram of the fifth embodiment of the data transmission method provided by the present application, and the method is applied to servers, comprising the following steps:
S51, obtaining the health data from wearable device sent by the mobile terminal;
Obtain from wearable devices health data sent by mobile terminals.

S52, obtaining from mobile terminal the authorization permission that is generated by the mobile terminal based on the authorization information input by the user;

Obtain from mobile terminal the authorization permission that is generated by the mobile terminal based on the authorization information input by the user;

Optionally, the authorization information includes private key information. After obtaining authorization permission, the server can encrypt and store the private key information for subsequent decryption.

S53, storing health data in a distributed manner;

Store health data in a distributed manner.

S54, distributing health data to third parties based on the authorization permission, and generating point reward information; and

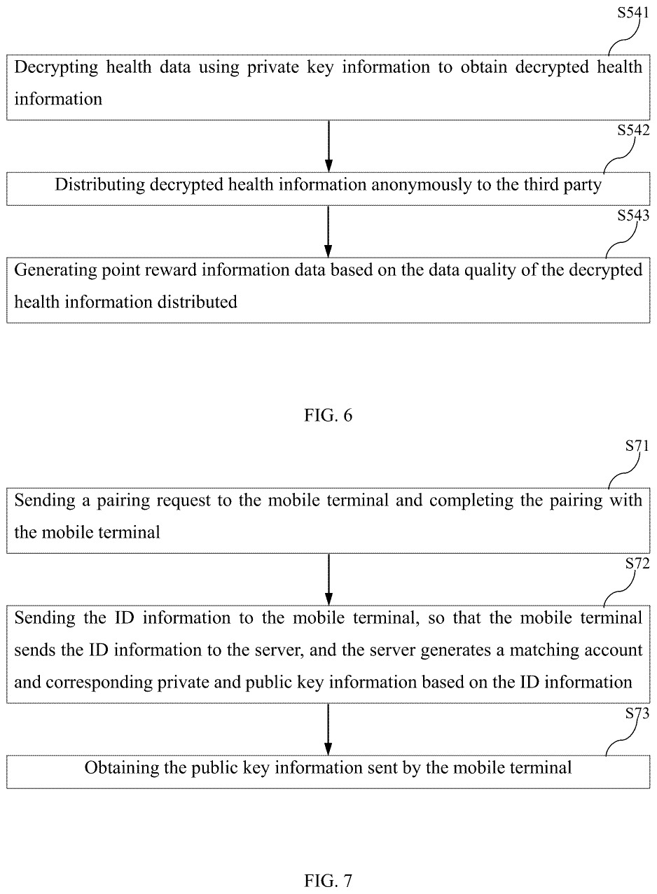

Subsequently, based on the authorization permission, the health data is distributed to third parties and point reward information is generated and, specifically, FIG. 6 is a flow diagram of sub steps of step S53 in FIG. 5, including the following sub steps:

S541, decrypting health data using private key information to obtain decrypted health information.

Decrypt health data using private key information to obtain decrypted health information and alternatively, since health data is encrypted using a public key, decrypted health information can be obtained after health information is decrypted using the corresponding private key.

S542, distributing decrypted health information anonymously to the third party.

Subsequently, the decrypted health information is anonymously distributed to the third party and specifically, the corresponding matching information will be deleted from the decrypted health information and simply sent as information to the third party.

S543, generating point reward information data based on the data quality of the decrypted health information distributed.

Subsequently, based on the data quality of the decrypted health information distributed, the point reward information data is generated and, optionally, the data quality specifically includes the overall duration of data (such as 3-day or 4-day data), the dimension of data volume (such as only including sleep data, or also including sleep and blood oxygen data), and so on, which are not limited here.

In some embodiments, the generation of the point reward information may be implemented by the server according to predetermined evaluation criteria corresponding to the data quality of the distributed health information. The evaluation criteria may include, for example, the duration of continuous health data recording, the frequency of sampling, the number and type of physiological parameters included, and whether the data meet preset completeness thresholds. Based on these criteria, the server may determine a corresponding reward level or numerical value representing the point reward information. In certain implementations, the server may further consider whether the health data have been authorized for distribution to third parties in accordance with the user's authorization permissions when determining the final reward value. Such implementation allows one skilled in the art to realize the generation of point reward information without further inventive effort, and clarifies that the point reward information reflects the data quality and authorized distribution status of the uploaded health data.

S55, sending point reward information to the mobile terminal.

Subsequently, the incentive reward information is sent to the mobile terminal and, optionally, the point reward information specifically includes points, virtual currency, and corresponding acquisition notification, the points and virtual currency can be sent to the mobile terminal and saved locally, or the server can store the corresponding point reward information in a matching account, that is, the points and virtual currency corresponding to the point reward information can be stored in their corresponding matching accounts, and the corresponding acquisition notification can be sent to the mobile terminal, which are not limited here.

Optionally, rewarding users through point reward information can enhance their interactivity and enhance their initiative to share data, greatly improving the playability.

FIG. 7 presents a flow diagram of the sixth embodiment of the data transmission method provided by the present application, and the method is applied to wearable devices, comprising the following steps:

S71, sending a pairing request to the mobile terminal and completing the pairing with the mobile terminal.

Send a pairing request to the mobile terminal and complete the pairing with the mobile terminal.

S72, sending the ID information to the mobile terminal, so that the mobile terminal sends the ID information to the server, and the server generates a matching account and corresponding private and public key information based on the ID information;

Send the ID information to the mobile terminal, so that the mobile terminal sends the ID information to the server, and the server generates a matching account and corresponding private and public key information based on the ID information;

S73, obtaining the public key information sent by the mobile terminal.

Obtain the public key information sent by the mobile terminal.

The specific process has already been explained in the above embodiments, which will not be repeated here.

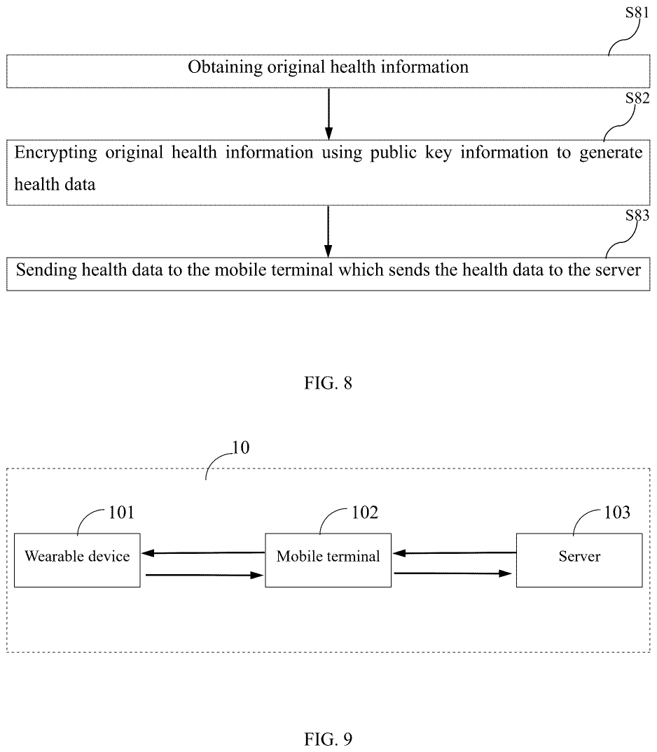

FIG. 8 presents a flow diagram of the seventh embodiment of the data transmission method provided by the present application, and the method is applied to wearable devices, comprising the following steps:

S81, obtaining original health information;

Obtain original health information, and when a wearable device is worn on the user's hand, the wearable device can perceive and obtain the original health information by using its own sensor.

Optionally, the wearable device can be used to obtain original health information, and can maintain a more continuous and long-term acquisition compared to mobile terminals. Wearable devices, for example, can be devices like rings that users do not have much perception of.

S82, encrypting original health information using public key information to generate health data;

Subsequently, encrypt original health information using public key information to generate health data.

S83, sending health data to the mobile terminal which sends the health data to the server.

Subsequently, send health data to the mobile terminal which sends the health data to the server.

The specific process has already been explained in the above embodiments, which will not be repeated here.

As shown in FIG. 9, the present application also provides a data transmission system 10, wherein the transmission system 10 comprises wearable device 101, mobile terminal 102, and server 103:
the wearable device 101 is used to obtain original information, generate health data by encrypting the original health information based on public key information, and to send health data to the mobile terminal 102; the mobile terminal 102 is used to obtain the health data sent by wearable device and the authorization information input by users, generate authorization permission based on the authorization information, and send the health data and authorization permission to the server 103; the server 103 is used to obtain health data and authorization permission sent by the mobile terminal 102, store the health data in a distributed manner and, based on the authorization permission, distribute the health data to third parties, and generate and send point reward information to the mobile terminal 102.

In summary, the above embodiments provide a data transmission method to obtain from wearable device the health data that is generated by the wearable device through the encryption of original health information based on public key information; obtain authorization information input by the user; generates authorization permissions based on authorization information; send health data and authorization permissions to the server so that the server will implement distributed storage of health data and, based on the authorization permission, distribute health data to third parties and generate point reward information; and obtain the point reward information sent by the server. On the one hand, the use of wearable devices to obtain health data instead of directly through mobile terminals greatly improves the convenience and sustainability of health data acquisition, and the use of public keys to encrypt the incoming and outgoing data, whether from wearable devices to mobile terminals or from mobile terminals to servers, disables the data interpretation, and the authorization permission is sent to the server for data distribution only after the user's authorization information is obtained, thus effectively protecting data, preventing unauthorized use by third parties, and reducing data leakage; on the other hand, with the consent of authorization, the server will receive reward information for data completion, thereby improving playability.

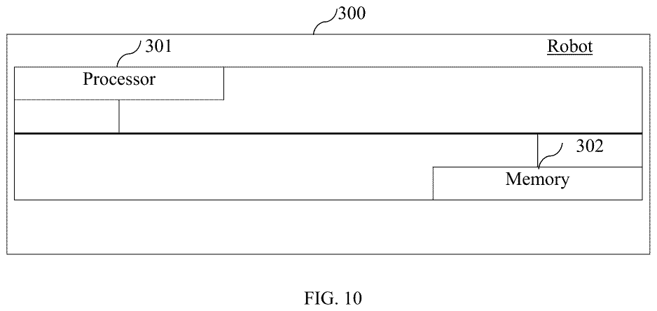

FIG. 10 presents a schematic block diagram of the structure of a data transmission device 300 provided by an embodiment of the present application. In FIG. 10, the data transmission device 300 includes a processor 301 and a memory 302, and both the processor 301 and memory 302 are connected by a bus, which can be any suitable bus such as I2C (Inter-integrated Circuit) bus.

Memory 302 can include storage media and internal memory. Storage media can store operating systems and computer programs. The computer program includes program instructions that, when executed, can cause the processor to perform any of the data transmission methods described in the embodiments.

Processor 301 is used to provide computing and control capabilities, supporting the operation of the entire data transmission device 300.

Processor 301 can be a central processing unit (CPU), can also be a general-purpose processor, a digital signal processor (DSP), an application specific integrated circuit (ASIC), a field-programmable gate array (FPGA), or other types of processors such as programmable logic devices, discrete gate or transistor logic devices, discrete hardware components, etc. A general-purpose processor can be a microprocessor, or any conventional one, etc.

Processor 301 is used to run the computer program stored in the memory 302 and implement any of the steps in the above embodiments when executing the computer program. The embodiments of the present application also provide a computer-readable storage medium, wherein the computer-readable storage medium stores computer programs which, when executed by a processor, enable the processor to implement the data transmission method as described above. The computer program, for example, is loaded by a processor and can perform any of the steps described in the above embodiments.

The specific implementation of the above operations is detailed in the previous embodiments, which will not be elaborated here.

The computer-readable storage medium may be the internal storage unit of the data transmission device in the aforementioned embodiments, such as a hard disk or memory of data transmission device. Computer-readable storage media can also be an external storage device for data transmission device, such as plug-in hard drives, smart media cards (SMC), secure digital (SD) cards, and flash cards on a data transmission device.

The scope of protection of the present application is not limited to above embodiments, which are only the specific ones of the present application, and a person skilled in the art can readily think of various equivalent modifications or substitutions within the technical scope disclosed in the present application, and these modifications or substitutions should be covered within the scope of protection of the present application. Therefore, the scope of protection of this application should be based on the scope of protection of the claims.

1. A data transmission method, wherein the transmission method is applied to a mobile terminal, comprising:
obtaining wearable device, the health data is generated by the wearable device through the encryption of original health information based on public key information;
obtaining authorization information input by the user;
generating authorization permissions based on authorization information;
sending health data and authorization permissions to the server so that the server will implement distributed storage of health data and, based on the authorization permission, distribute health data to third parties and generate point reward information; and
obtaining the point reward information sent by the server.

2. The data transmission method according to claim 1, wherein generating an authorization permission based on the authorization information comprises:
generating the authorization permission when the authorization information indicates consent to authorization;
the authorization permission includes private key information.

3. The data transmission method according to claim 1, wherein before generating an authorization permission based on the authorization information, comprises:
receiving pairing requests from the wearable device;
completing pairing with the wearable device based on the pairing request.

4. The data transmission method according to claim 3, further comprising:
obtaining ID information of wearable device;
sending the ID information to the server so that the server generates a matching account and corresponding private and public key information based on the ID information, and receiving the private and public key information issued by the server;
sending the public key information to the wearable device.

5. A data transmission method, wherein the transmission method is applied to a server, comprising:
obtaining the health data from wearable device sent by the mobile terminal;
obtaining from mobile terminal the authorization permission that is generated by the mobile terminal based on the authorization information input by the user;
storing health data in a distributed manner;
distributing health data to third parties based on the authorization permission, and generating point reward information; and
sending point reward information to the mobile terminal.

6. The transmission method according to claim 5, wherein the authorization permission includes private key information, and distributing health data to third parties and generating point reward information based on the authorization permission comprises:
decrypting health data using private key information to obtain decrypted health information;
distributing decrypted health information anonymously to the third party;
generating point reward information data based on the data quality of the decrypted health information distributed.

7. The transmission method according to claim 5, wherein before obtaining the health data sent by the mobile terminal, comprises:
obtaining the ID information from wearable device sent by the mobile terminal;
generating matching accounts and corresponding private and public key information based on the ID information;
sending the private key information and public key information to the mobile terminal.

8. The transmission method according to claim 7, further comprising:
storing the point reward information in the matching account.

9. A data transmission method, wherein the transmission method is applied to wearable device, comprising:
obtaining original health information;
encrypting original health information using public key information to generate health data;
sending health data to the mobile terminal which sends the health data to the server.

10. The transmission method according to claim 9, wherein before obtaining the original health information, comprising:
sending a pairing request to the mobile terminal and completing the pairing with the mobile terminal.

11. The transmission method according to claim 10, further comprising:
sending the ID information to the mobile terminal, so that the mobile terminal sends the ID information to the server, and the server generates a matching account and corresponding private and public key information based on the ID information;
obtaining the public key information sent by the mobile terminal.

12. A data transmission system, wherein the transmission system comprises wearable device, mobile terminal, and server:
the wearable device is used to obtain original information, generate health data by encrypting the original health information based on public key information, and to send health data to the mobile terminal;
the mobile terminal is used to obtain the health data sent by wearable device and the authorization information input by users, generate authorization permission based on the authorization information, and send the health data and authorization permission to the server;
the server is used to obtain health data and authorization permission sent by the mobile terminal, store the health data in a distributed manner and, based on the authorization permission, distribute the health data to third parties, and generate and send point reward information to the mobile terminal.

13. A data transmission device to carry out the data transmission method of claim 1. comprising:
a memory configured to store computer programs; and
a processor configured to, when executing the computer programs,
obtain health data generated by a wearable device through encryption of original health information based on public key information,
obtain authorization information input by a user,
generate authorization permissions based on the authorization information,
send the health data and authorization permissions to a server so that the server implements distributed storage of the health data and, based on the authorization permissions, distributes the health data to third parties and generates point reward information, and
obtain the point reward information sent by the server.

14. The data transmission device according to claim 13, wherein the processor is further configured to, when executing the computer programs,
generate an authorization permission when the authorization information indicates consent to authorization,
wherein the authorization permission includes private key information.

15. The data transmission device according to claim 13, wherein the processor is further configured to, when executing the computer programs,
obtain identification information of a wearable device;
send the identification information to a server so that the server generates a matching account and corresponding private and public key information based on the identification information;
receive the private and public key information issued by the server; and
send the public key information to the wearable device.

16. A data transmission device to carry out the data transmission method applied to a server in claim 5, comprising:
a memory configured to store computer-executable instructions; and
a processor configured to, when executing the instructions,
obtain health data sent by a mobile terminal from a wearable device;
obtain from the mobile terminal authorization permissions that are generated by the mobile terminal based on authorization information input by a user;
store the health data in a distributed manner;
distribute the health data to third parties based on the authorization permissions and generate point reward information; and
send the point reward information to the mobile terminal.

17. The data transmission device according to claim 16, wherein the processor is further configured to, when executing the computer programs,
use private key information included in the authorization permissions to decrypt the health data to obtain decrypted health information;
distribute the decrypted health information anonymously to a third party; and
generate point reward information based on the data quality of the decrypted health information distributed.

18. The data transmission device according to claim 16, wherein the processor is further configured to, when executing the computer programs,
obtain identification information of a wearable device sent by a mobile terminal;
generate matching accounts and corresponding private key information and public key information based on the identification information; and
send the private key information and public key information to the mobile terminal.

19. The data transmission device according to claim 18, wherein the processor is further configured to, when executing the computer programs,
store the point reward information in the matching account.

20. A data transmission device to carry out the data transmission method applied to a wearable device in claim 9, comprising:
a memory configured to store computer-executable instructions; and
a processor configured to, when executing the instructions,
obtain original health information;
encrypt the original health information using public key information to generate health data; and
send the health data to a mobile terminal so that the mobile terminal sends the health data to a server.

21. The data transmission device according to claim 20, wherein the processor is further configured to, when executing the computer-executable instructions,
send a pairing request to a mobile terminal and complete pairing with the mobile terminal before obtaining the original health information.

22. The data transmission device according to claim 20, wherein the processor is further configured to, when executing the computer programs,
send identification information to a mobile terminal so that the mobile terminal sends the identification information to a server, and the server generates a matching account and corresponding private key information and public key information based on the identification information; and
obtain the public key information sent by the mobile terminal.

23. A computer-readable storage medium to carry out the data transmission method applied to a mobile terminal in claim 1, wherein the computer-readable storage medium stores computer programs which, when executed by a processor, cause the processor to:
obtain health data generated by a wearable device through encryption of original health information based on public key information;
obtain authorization information input by a user;
generate authorization permissions based on the authorization information;
send the health data and authorization permissions to a server so that the server implements distributed storage of the health data and, based on the authorization permissions, distributes the health data to third parties and generates point reward information; and
obtain the point reward information sent by the server.

24. The computer-readable storage medium according to claim 23, wherein the computer programs, when executed by the processor, further cause the processor to:
generate an authorization permission when the authorization information indicates consent to authorization; and
include private key information in the authorization permission.

25. The computer-readable storage medium according to claim 23, wherein the computer programs, when executed by the processor, further cause the processor to:
receive a pairing request from a wearable device; and
complete pairing with the wearable device based on the pairing request before generating an authorization permission based on the authorization information.

26. A computer-readable storage medium to carry out the data transmission method applied to a server in claim 5, wherein the computer-readable storage medium stores computer programs which, when executed by a processor, cause the processor to:
obtain health data sent by a mobile terminal from a wearable device;
obtain from the mobile terminal authorization permissions that are generated by the mobile terminal based on authorization information input by a user;
store the health data in a distributed manner;
distribute the health data to third parties based on the authorization permissions and generate point reward information; and
send the point reward information to the mobile terminal.

27. The computer-readable storage medium according to claim 26, wherein the computer programs, when executed by the processor, further cause the processor to:
use private key information included in the authorization permissions to decrypt health data to obtain decrypted health information;
distribute the decrypted health information anonymously to a third party; and
generate point reward information data based on the data quality of the decrypted health information distributed.

28. The computer-readable storage medium according to claim 26, wherein the computer programs, when executed by the processor, further cause the processor to:
obtain identification information of a wearable device sent by a mobile terminal;
generate matching accounts and corresponding private key information and public key information based on the identification information; and
send the private key information and public key information to the mobile terminal.

29. A computer-readable storage medium to carry out the data transmission method applied to a wearable device in claim 9, wherein the computer-readable storage medium stores computer programs which, when executed by a processor, cause the processor to:
obtain original health information;
encrypt the original health information using public key information to generate health data; and
send the health data to a mobile terminal so that the mobile terminal sends the health data to a server.

30. The computer-readable storage medium according to claim 29, wherein the computer programs, when executed by the processor, further cause the processor to:
send a pairing request to a mobile terminal; and
complete pairing with the mobile terminal before obtaining the original health information.
